(19) United States
(12) Patent Application Publication
(10) Pub. No.: US 2014/0281222 A1
(43) Pub. Date: Sep. 18, 2014

(54) ANTIHARMONIC DATA COPYING METHOD

(71) Applicant: Ching-Chung Lee, Taichung (TW)

(72) Inventor: Ching-Chung Lee, Taichung (TW)

(21) Appl. No.: 14/289,969

(22) Filed: May 29, 2014

Related U.S. Application Data
(63) Continuation-in-part of application No. 13/299,038, filed on Nov. 17, 2011.

(51) Int. Cl. G06F 3/06

(52) U.S. Cl. CPC G06F 3/0689; G06F 3/0619; G06F 3/0665
USPC 711/114

(57) ABSTRACT

A data copying method for one-to-many reproduction apparatus having a data buffer includes steps of: reading multiple data segments from source data into the data buffer, detecting newly connected random access devices, selecting the data segments from the data buffer individually for each of the random access devices, copying the respectively selected data segments into each of the random access devices, and determining whether each of the data segments in the data buffer has been copied into all the random access devices and whether any of the random access devices has stored all the data segments of the source data. Newly connected devices are allowable to improve efficiency. Segment selection prevents multiple devices from writing identical data synchronously and thereby prevents accumulation of identical electromagnetic leakage. Consequently, electromagnetic interference is reduced.

This application is a continuation in part of Applicant Ching-Chung Lee's U.S. patent application Ser. No. 13/299,038 filed Nov. 17, 2011 entitled Data Copying Method For Copying Data From Buffer To A Plurality Of Random Access Devices With Low Electromagnetic Interference and currently under examination with examiner Bansal, Gurtej in Art Unit 2189 having an attorney docket number of 2450/2461PUS1, which was originally entitled Data Copying Method For One-To-Many Reproduction Apparatus.

### FIELD OF THE INVENTION

The present invention is in the field of data copying methods.

### BACKGROUND OF THE INVENTION

The present invention relates to a method for reproducing mass data and particularly to a method for reproducing mass electromagnetic data through a one-to-many reproduction apparatus to multiple random access devices. With rapid advances in technology, random access devices such as Universal Serial Bus (USB) disks, hard drives and memory cards have been well developed and have replaced earlier storage media diskettes to become the most commonly used media for modern people to carry electronic data. Thus, data reproduction for random access devices becomes an important issue.

Take an USB disk as an example. For data copying, users generally directly insert the USB disk into a USB port of a computer to do copying. However, due to the limited number of USB ports on the computer, in the event that data have to be copied to a great number of USB disks, a one-to-many reproduction apparatus such as an USB duplicator is preferred. When using an USB duplicator, all targeted USB disks must be inserted first. Then, data segments of source data are read sequentially from beginning to end and written into a data buffer of the USB duplicator for caching; meanwhile the data segments saved in the data buffer are copied sequentially and synchronously via the USB ports to all the targeted USB disks until all the data segments of the source data have been written into the targeted USB disks.

However, such a copying approach has drawbacks, notably:
1. During data copying of the USB duplicator, no new USB disks can be added into the data copying process even if there are idle USB ports. Only after the current data copying process has been finished, can a user insert new USB drives into the USB ports and be written in a succeeding copying process. Hence usability suffers and more waiting time is consumed. Moreover, as additional repeated processes are needed, more power is consumed by the USB duplicator.
2. The USB duplicator performs sequential copying and the same data segments are transmitted to all connected USB disks synchronously. When the same data are transmitted and written into a great number of USB disks at the same time, the leaked electromagnetic waves accumulate to generate higher electromagnetic interference (EMI) and may have inappropriate harmonic resonance. As the regulations of electromagnetic interference in many countries become more strict and modern people prefer home appliances with low electromagnetic wave, there remains room for improvement in the data copying method.

### SUMMARY OF THE INVENTION

The primary object of the present invention is to overcome the problems of inefficient copying and high EMI of the conventional data copying method, that could be due to unintended EMI harmonics, or from plain noise. To achieve the foregoing object, the present invention provides a data copying method for a one-to-many reproduction apparatus to which a plurality of random access devices are connected. The one-to-many reproduction apparatus includes a data buffer for caching source data and at least two I/0 connection ports for connecting target random access devices. The data copying method includes the following steps: a reading step to read a plurality of data segments from source data into the data buffer for saving therein; a detecting step to detect whether any new random access devices are connected; a copying step to select the data segments saved in the data buffer individually for each of the random access devices and copy the respectively selected data segments into each of the random access devices; a first determining step to determine whether each of the data segments in the data buffer has been copied into all the random access devices, and if one data segment in the data buffer has been copied into all the random access devices, read a new data segment from the source data into the data buffer to replace the data segment that has been copied to all the random access devices; and a second determining step to determine whether any of the random access devices has saved all the data segments of the source data, and if one random access device has saved all the data segments of the source data, the copying of that random access device is finished. The one-to-many reproduction apparatus can inform the operator to take out the finished random access device and the operator can insert a new target random access device.

The invention optionally further includes a comparing step to read the data segment already copied into each of the random access devices and compare the read data segment with the original data segment of the source data to check consistency.

In more detail, as a random access device can be written m any order, in the event that a newly connected random access device is detected during the data copying process, the newly connected random access device can accept the data segments in the data buffer immediately and store the accepted data segments in corresponding addresses even if the data segments currently saved in the data buffer belong to the middle portion of the source data. In other words, data copying can be performed from the middle portion of the source data for the newly connected random access device while the data segments belonging to the preceding portion can be written in later copying steps and eventually the random access device will contain all the data segments of the source data.

As a result the invention provides many advantages, notably:
1. A new random access device can be connected to any idle I/0 connection port during data copying process. When the one-to-many reproduction apparatus detects the newly connected random access device, it schedules the newly connected random access device into the current data copying process immediately, thus improves usability and practicality.
2. The data segments copied into multiple random access devices are individually selected, so simultaneous transmission of the same data segment to multiple random access devices can be avoided, and thereby accumulation of the same leaked electromagnetic signals can be prevented and less EMI is generated.
3. Due to the reduced EMI, under the same EMI regulation, data copying can be performed on more random access devices through a transmission interface with higher speed, and therefore data copying will be more efficient.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the basic structure of the invention.

FIG. 2 is a flowchart of the invention.

FIG. 3 is a schematic view of the structure of a first embodiment of the invention.

FIG. 4 is a schematic view of the structure of a second embodiment of the invention.

FIG. 5 is a schematic views of the structure of a third embodiment of the invention.

FIG. 6 is a schematic views of the structure of a third embodiment of the invention.

### DETAILED DESCRIPTION OF THE PREFERRED EMBODIMENTS

Please refer to FIG. 1, the present invention aims to provide a data copying method for a one-to-many reproduction apparatus. The one-to-many reproduction apparatus 1 includes a data buffer 2 and a plurality of I/0 connection ports 3, to which a plurality of random access devices are connected. The data buffer 2 is connected to a source data carrier 4 to get source data. The I/0 connection ports 3 are connected to the data buffer 2 and the source data are transmitted to random access devices 5, such as USB disks, via the I/0 connection ports 3.

Also referring to FIG. 2, the data copying method of the invention includes the steps of:
a reading step S1 to read a plurality of data segments from the source data into the data buffer 2 for saving therein; during execution of this step, the one-to-many reproduction apparatus 1 divides the source data into multiple data segments to facilitate transmission of the data segments to the data buffer 2;
a detecting step S2 to detect, via the one-to-many reproduction apparatus 1, whether any new random access devices 5 are connected to the 1/0 connection ports 3; if newly connected random access devices 5 are detected, they will be scheduled into the data copying process;
a copying step S3 to select the data segments from the data buffer 2 individually for each of the random access devices 5 and copy the respectively selected data segments into each of the random access devices 5; selection of the data segments can be performed in various ways, such as random selection to avoid selecting the same data segment for each of the random access devices 5 all the time; or sequential selection of the data segments in the data buffer 2 for each of
the random access device 5 from different starting points to avoid selecting the same data segment for each of the random access devices 5 all the time;
a first determining step S4 to determine whether each of the data segments in the data buffer 2 has been copied into all the random access devices 5, and if one data segment in the data buffer 2 has been copied into all the random access devices 5, read a new data segment from the source data into the data buffer 2 to replace the data segment that has been copied to all the random access devices 5; and
a second determining step S5 to determine whether any of the random access devices 5 has saved all data segments of the source data; if one random access device 5 has saved all the data segments of the source data, finish the data copying of that random access device 5 and inform the operator of the one-to-many reproduction apparatus 1 to remove the finished random access device 5. Repeat the steps set forth above to continue the data copying process.

The invention further may include a comparing step to read the data segment already copied into each of the random access devices 5 and compare the read data segment with the original data segment of the source data to check consistency to confirm that the data segments copied into each of the random access devices 5 are correct. Please note that this comparing step is not illustrated in the figures.

Please refer to FIG. 3 for the structure of a first embodiment of the invention. The random access devices 5 are two USB disks 5a and 5b that are inserted into the I/0 connection ports 3 of a one-to-many reproduction apparatus 1 which is further connected to a source data carrier 4. In practice, the random access devices 5 are not limited to the USB disks, and they may be other carriers capable of storing electromagnetic data, such as hard disks, memory cards and the like.

When the copying process is performed through the one-to-many reproduction apparatus 1, the source data in the source data carrier 4 are divided by the one-to-many reproduction apparatus 1 into multiple data segments. In this embodiment, the source data are divided into five data segments A, B, C, D and E, and then the reading step S1 is executed to read the data segments from the source data into the data buffer 2. Reading the data segments into the data buffer 2 can be performed sequentially or non-sequentially. The sequential reading is to sequentially read the data segments in the order of, for example, A, B, C, while the non-sequential reading is to read the data segments in the order of, for example, B, D, A. In this embodiment, the data segments A, B, C and D are read sequentially into the data buffer 2. During execution of the detecting step S2, the one-to-many reproduction apparatus 1 detects that two USB disks 5a and 5b are connected thereto and confirms that no other new USB disk is connected.

Next, the copying step S3 is executed. It is to select one of the data segments A, B, C and D saved in the data buffer 2 respectively for each of the USB disks 5a and 5b and copy the respectively selected segment into each of the USB disks 5a and 5b. In this embodiment, the selection of the data segments is random selection. The data segment B is selected for and copied into the USB disk 5a; the data segment C is selected for and copied into the USB disk 5b.

During data copying process, the first determining step S4 is to determine whether each of the data segments in the data buffer 2 has been copied into the USB disks 5a and 5b. In the event that none of the data segments in the data buffer 2 has been copied into both of the USB disks 5a and 5b, the second determining step SS is directly executed then. If there is one data segment having been copied into both of the USB disks 5a and 5b, a new data segment is read from the source data into the data buffer 2 to replace the data segment already copied into both of the USB disks 5a and 5b.

Next, the step S5 is executed to determine whether any of the USB disks 5a and 5b has saved all the data segments of the source data; if the USB disk 5a, for example, has saved all the data segments of the source data, it means that the data copying of the USB disk 5a is finished and the one-to-many reproduction apparatus 1 can inform the operator to remove the finished USB disk 5a.

Please refer to FIG. 4 for a second embodiment of the invention. During data copying process, a new USB disk 5c is inserted into an idle I/0 connection port 3 of the one-to-many reproduction apparatus 1. At this moment the data copying method of the invention has been executed on the one-to-many reproduction apparatus 1, when the one-to-many reproduction apparatus 1 detects that the newly connected USB disk 5c is connected according to the detecting step S2, it schedules the newly connected USB disk 5c into the copying process immediately. Then the detecting step S2, copying step S3, first determining step S4 and second determining step S5 are repeated to make the USB disks 5a, 5b and 5c contain all the data segments of the source data.

Please refer to FIGS. 5 and 6 for a third embodiment of the invention that describe the first determining step S4 in detail. During the data copying process of the USB disks 5a, 5b and 5c, the first determining step S4 determines that data segment B in the data buffer 2 has been copied into all of the USB disks 5a, 5b and 5c, and then the one-to-many reproduction apparatus 1 reads a new data segment E from the source data into the data buffer 2 to replace the data segment B.

Data Segment Selection Means

A data segment selection means can implement an antiharmonic data copying algorithm such as the variety of different methods listed below.

(1) Arbitrary Selection

For each connected target random access device, whenever writing is to be performed, a data segment selection means can arbitrarily (or randomly) select a data segment from the data buffer. In other words, a random number generator (RNG) determines which data segment can be selected for the target random access device. A random number can be generated based on physical phenomenon, such as values of a timer. Computational methods can be used to generate a pseudo-random number using the CPU. Due to the randomness, it is possible that the same data segment is selected repeatedly for the same target. If this happens, the selection must be carried out again until a never-before-selected data segment is selected. For better performance, a history of selection can be kept to exclude a candidate that is already selected.

(2) Confined Arbitrary Selection

As mentioned above, the data segment selection means can include maintaining a history of selection to improve the performance. For each target random access device, an entry is required for each data segment in the data buffer. If, for example, there are 100 targets connected and 100 data segments in the data buffer, 100 times 100 entries are required. To ease the memory consumption, selection candidates for each target can be confined in a smaller candidate area, which is advancing as the data segments in this area are selected and copied. For example, initially, the candidate area for a specific target covers data segments 0˜7 of the data buffer, and if data segments 0, 1, and 2 have been selected and copied, this candidate area will advance to cover the data segment 3˜10 of the data buffer. Thus, if the candidate area covers 8 data segments, only 100 times 8 entries are required for the selection history.

(3) Mutually-prime Step

The data segment selection means can also use a mutually prime step algorithm. A step here is defined as the size of advance, in units of a data segment, in the data buffer. For example, data segment selection with a step of 3 means that data segments N, N+3, N+6, and N+9 of the data buffer are selected in sequence. In this method, each random access device is assigned a unique step value, and the segment selection is performed according to the step value for each random access device. For example, for a random access device with the step value 3, data segments 0, 3, 6, 9 of the data buffer are selected in sequence. In the same period, for another random access device with the step value 2, data segments 0, 2, 4, 6 of the data buffer are selected in sequence. As a result, different data segments are transferred simultaneously. When a segment number goes beyond the quantity of data segments inside the data buffer, a wrapping-around is carried out. To avoid repeated selection, it is preferred that the step values are mutually-prime with the number of data segments inside the data buffer.

(4) Selection according to Registration

In the method mentioned above, the selection of data segments for a random access device is independent from the selection for other random access devices. In the method to be described here, when a selection is carried out for a random access device, a query is made to determine if a data segment is being selected and copied now by other devices. In this method, each data segment in the data buffer has a flag to indicate if it is being selected and copied now. When a random access device needs a data segment, it searches the data buffer for a data segment with an unset flag. If a data segment with an unset flag is found, set that flag and copy that data segment into the random access device. After the copying is finished, that flag is unset again.

(5) Variable Data Segment Count

In this method, multiple data segments are selected and copied at a time for each random access device, and the selection is carried out contiguously. For simplicity, here the data segment count in each selection is limited to 3 or 2, and is determined by a random number generator. Furthermore, for better diversity, data segments in each selection may be shuffled. For example, for a random access device, un-shuffled data segments 1, 2, and 3 of the data buffer are selected first, and then shuffled data segments 5 and 4 are selected. Then shuffled data segments 7 and 6, and un-shuffled data segments 8, 9, and 10 are selected and copied. As a result, due to the randomness, each random access device has its own series of data segments that is different from others.

In conclusion, the data copying method for a one-to-many reproduction apparatus according to the present invention allows users to flexibly insert target random access devices to make data copying more efficient, and also prevents the same data segment from being transmitted to multiple random access devices at the same time to avoid accumulation of the same electromagnetic signals and hence to avoid high EMI. While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A data copying method for reducing electromagnetic interference comprising the steps of:
providing a reproduction apparatus;
providing ports configured to receive a plurality of removable random access devices wherein the ports are located on the reproduction apparatus, wherein each removable random access device has its own port;
copying data from a buffer to the plurality of removable random access devices;
making multiple copies of a source data onto the plurality of removable random access devices with each of the plurality of removable random access devices receiving a complete copy of the source data;
reading a plurality of data segments from the source data into a data buffer for saving in the data buffer;
detecting whether any new random access devices are connected;
implementing a data segment selection means for selecting different data segments from the data buffer for different random access devices and copying simultaneously the selected different data segments into the different random access devices in a single iteration;
determining whether each of the data segments in the data buffer has been copied into all the random access devices, and reading a new data segment from the source data into the data buffer to replace the data segment already copied into all the random access devices; and
determining whether any of the random access devices has saved all the data segments of the source data.

2. The data copying method of claim 1 further including a comparing step of reading the data segment copied into each of the random access devices and comparing the read data segment with original data segment of the source data to check consistency.

3. The data copying method of claim 1, wherein the reading step is to sequentially read the data segments from the source data, wherein the step of sequentially reading the data segments from the source data begins at different times on different random access devices.

4. The data copying method of claim 2, wherein the reading step is to sequentially read the data segments from the source data, wherein the step of sequentially reading the data segments from the source data begins at different times on different random access devices.

5. The data copying method of claim 1, wherein the reading step is to non-sequentially read the data segments from the source data.

6. The data copying method of claim 2, wherein the reading step is to non-sequentially read the data segments from the source data.

7. The data copying method of claim 1, wherein the random access devices are respectively selected from the group consisting of a USB disk, a hard disk and a memory card.
